(19) United States
(12) Patent Application Publication
(10) Pub. No.: US 2025/0100940 A1
(43) Pub. Date: Mar. 27, 2025

(54) ALKALINE POWDER KILN FURNITURE WITH CONTROLLED-POROSITY COATING

(71) Applicant: SAINT-GOBAIN CENTRE DE RECHERCHES ET D'ETUDES EUROPEEN, COURBEVOIE (FR)

(72) Inventors: Hassan SAAD, CAVAILLON (FR); Alain ALLIMANT, CAVAILLON (FR); Jérôme BRULIN, CAVAILLON (FR)

(21) Appl. No.: 18/721,600

(22) PCT Filed: Dec. 23, 2022
(86) PCT No.: PCT/FR2022/052495

§ 371 Date: Jun. 18, 2024

(30) Foreign Application Priority Data
Dec. 23, 2021 (FR) 2114403

(51) Int. Cl. C04B 35/622; C04B 35/10; C04B 38/00

(52) U.S. Cl. CPC C04B 35/62222; C04B 35/10; C04B 38/0058; C04B 2235/3206; C04B 2235/3217; C04B 2235/3244; C04B 2235/3418

(57) ABSTRACT

A kiln furniture for a powder includes an alkali, in particular Li, including a porous ceramic body forming a cavity or a container for the powder, wherein the ceramic body with open porosity of between 10 and 40% and with equivalent pore diameter between 0.5 and 25 micrometers is coated on at least part of its inner surface with a ceramic coating, the coating including a compound selected from alumina, a lithium aluminate optionally including silicon optionally silicon, aa magnesia-alumina spinel, zirconia, optionally stabilized, hafnia, yttria; having an average thickness of between 50 and 500 micrometers; a total porosity of less than 15% by volume and a volume fraction of pores of diameter greater than or equal to 2 micrometers that is less than 2.5%.

### TECHNICAL FIELD

The invention relates to the field of kiln furniture, in particular containers, crucibles or saggars, for the heat treatment of alkaline powders intended for the manufacture of batteries. These powders are in particular lithium-based powders used for the manufacture of cathodes making up the latest-generation batteries.

### PRIOR ART

Needs for lithium-ion batteries are constantly increasing. A good number of them comprise a part, generally the cathode, made of an oxide comprising lithium, in particular an oxide of a metal or of several lithiated transition metals, in particular LiFePO₄ (or LPF), LiMn₂O₄ (or LMO), or a lithium-nickel-cobalt-manganese (or NMC) oxide.

The cathode is generally manufactured by shaping a powder of said oxide of a metal or several alkali transition metals, in particular lithiated ones.

Among the conventional methods for manufacturing said powders, the production of a mixture of oxides and/or of different oxide precursors, followed by a heat treatment at a temperature above 800° C., makes it possible to carry out a solid-phase synthesis of the oxide of a metal or of several alkali transition metals.

During said heat treatment, the mixture is placed in a kiln furniture, in particular a saggar. The conditions for synthesizing said powders, as well as said mixture, in particular the elements containing lithium, are particularly demanding for the kiln furniture containing lithiated powders.

Known solutions of monolithic crucibles for example as described in application US2021269365A1 remain perfectible in terms of their lifetime.

Kiln furniture solutions formed by assembling different plates, such as for example those disclosed by WO2021151917A1, make it possible to adapt and replace certain parts of the container that are most stressed, but remain complex to implement.

Other solutions, particularly repair solutions, have been proposed in the publication CN112537967A, consisting for example of depositing a layer by cold-spraying a suspension whose formulation comprises alumina, quartz, titanium oxide, tungsten carbide, a sintering agent, and shaping agents. CN111233482A also proposes a saggar with a sintered coating from a deposition mineral formulation comprising silicon carbide, magnesia, talc and graphite. However, the corrosion resistance of this coating is insufficient.

KR20020050390A suggests an alumina saggar coated with a deposit of 30 to 500 μm of zirconia, followed by sintering at between 40° and 1500° C. in order to improve the chemical resistance of the coating to ferrite or barium titanate powders.

KR20010045759A provides an alumina saggar provided with a rough layer of zirconia of 30 to 1000 μm deposited by thermal spraying at a specified angle in order to reduce the deposition cost and improve the mechanical properties of the coating.

Although with this latter coating solution obtained by plasma spraying, the corrosion resistance is improved, the performance of these solutions therefore remains insufficient with respect to the most highly aggressive alkali metal powders.

There is therefore a need for a kiln furniture for alkali metal powders, in particular lithium powders, having a better compromise between the following various requirements:
stability of the coating of the kiln furniture while in service in order to eliminate any possibility of contamination of the powder to be fired;
ease of cleaning after the heat-treated powder has been evacuated and before re-use to fire new alkaline powders;
resistance to thermal stresses while in service (cracking due to thermal shocks and cycling, in particular).

### Overview of the Invention

The object of the invention is to propose kiln furnitures that make it possible, at least partially, to address this need, in particular, for containers in the form of a crucible or of a saggar that can be reused easily, are highly resistant to corrosion by alkali metals and in particular by lithium, and are highly resistant to thermal shocks and cycling.

To this end, the invention relates to a kiln furniture for a powder comprising an alkali metal, in particular Li, capable of being used for the heat treatment of a filler comprising an alkaline powder intended for the manufacture of batteries, comprising a porous ceramic body forming a cavity or a container for said powder, wherein said ceramic body is coated on at least part of its inner surface with a ceramic coating, wherein:
a) said porous body has, as measured by mercury and volume porosimetry, an open porosity of between 10 and 40%, and an equivalent or median diameter of pores of between 0.1 and 25 micrometers, preferably between 0.5 and 25 micrometers; preferably, the open porosity of said porous body is between 10 and 30%, more preferably between 10% and 20%;
b) said coating has the following characteristics:
   it comprises, and preferably consists of, a layer comprising a compound selected from alumina, a lithium aluminate optionally comprising silicon, in particular LiAlO₂, LiAlSi₂O₆, Li₃AlSiO₅, LiAlSi₄O₁₀, LiAlSiO₄, a magnesia-alumina spinel, zirconia, preferably stabilized, hafnia, yttria. Preferably, said compound is selected from alumina, a lithium aluminate optionally comprising silicon, in particular LiAlO₂, LiAlSi₂O₆, LisAlSiO₅, LiAlSi₄O₁₀, LiAlSiO₄, a magnesia-alumina spinel.
   its average thickness is between 50 and 500 micrometers; preferably between 100 and 300 micrometers;
   its total porosity is less than 15%, by volume; preferably less than 12%, preferably less than 10% by volume;
   its volume fraction of pores with a diameter greater than or equal to 2 micrometers is less than 2.5%; preferably less than 2.2%, preferably less than 2%.

According to preferred embodiments of the present invention, which can, if appropriate, be combined with one another:
the median pore diameter d₅₀ of said ceramic coating is between 0.1 and 1.5 micrometers. Preferably, the median pore diameter d₅₀ of said ceramic coating is greater than 0.5 micrometers and/or less than 1 micrometer;
the pore diameter doo of said material is less than 2.5 micrometers.
the median size of grains of said ceramic coating is between 5 and 100 micrometers. Preferably, said size is greater than 10 micrometers and/or less than 70 micrometers, preferably less than 50 micrometers, preferably less than 30 micrometers;
the mass content of alkali metal oxides except Li₂O in said ceramic coating is less than 0.5%. In particular, the mass content of Na₂O and/or K₂O in said ceramic coating is preferably less than 0.5%, preferably less than 0.2%, preferably is less than 0.1%;
the mass content of SiO₂ in said ceramic coating is less than 0.5%, preferably less than 0.2%; more preferably is less than 0.1%;
the chemical composition of said ceramic coating in metal oxides Cr₂O₃, Fe₂O₃, ZnO or CuO capable of reacting with the alkali powders is such that the mass content of said coating in the sum of the oxides Cr₂O₃+ZnO+Fe₂O₃+CuO is less than 0.5%. In particular, the mass content of Fe₂O₃ in said ceramic coating is less than 0.5%, preferably less than 0.2%;
the mass content of oxides other than Al₂O₃, MgO, Li₂O, Y₂O₃, ZrO₂, HfO₂ in said ceramic coating is less than 1%, preferably less than 0.5%; even more preferably is less than 0.2%;
the mass content of Al₂O₃ in said ceramic coating is greater than 98%, preferably greater than 98.5%, preferably greater than 99.0%, more preferably greater than 99.5%;
said porous ceramic body comprises alumina, zirconia, magnesia, mullite, cordierite, carbide and/or silicon oxynitride or oxynitride, boron nitride, boron carbide or molybdenum disilicide. Preferably, said porous ceramic body comprises alumina, zirconia, magnesia, mullite, cordierite, carbide and/or silicon oxynitride or oxynitride;
said porous ceramic body comprises and preferably consists of a ceramic matrix composite. Preferably, the ceramic matrix comprises alumina, zirconia, magnesia, mullite, cordierite, carbide and/or silicon nitride or oxynitride, including SiAlON and Si₂ON₂, boron nitride (BN), boron carbide (B₄C), or molybdenum disilicide (MoSi₂). Preferably, said matrix comprises alumina, zirconia, magnesia, mullite, cordierite, carbide and/or silicon oxynitride or oxynitride; The ceramic matrix composite preferably comprises fibers of alumina and/or mullite and/or SiC and/or carbon;
the mass content of the sum of the oxides ZrO₂+Al₂O₃+SiO₂+MgO in said porous ceramic body is greater than 95%, preferably greater than 98%, preferably greater than 99%;
the wall thickness of said porous ceramic body is preferably between 3 and 30 mm, preferably between 5 and 15 mm.

As explained in more detail in the rest of the text, a kiln furniture with a porous ceramic body provided with a controlled-porosity coating according to the invention solves the preceding technical problem in that it has excellent corrosion resistance and very low adhesion with alkali metals, in particular lithium, while remaining adherent to the furniture despite the thermomechanical stresses, which gives it an improved service life.

According to other optional and advantageous additional features of said kiln furniture and in particular of its ceramic coating, which may be combined with one another, if necessary:
the maximum pore diameter (D₁₀₀) of said ceramic coating is less than 7 micrometers.
the median pore diameter D₅₀ of said ceramic coating is between 0.1 and 5 micrometers, in particular between 0.5 and 5 micrometers, more preferably between 0.5 and 1.5 micrometers;
the median grain size of said ceramic coating measured by image analysis taken on polished sections observed with a scanning electron microscope is between 10 and 100 micrometers, preferably greater than or equal to 20 micrometers and/or less than 70 micrometers, even more preferably between micrometers and 50 micrometers;
the thickness of said ceramic coating is less than 500 micrometers, preferably less than 400 micrometers, preferably less than 300 micrometers and/or greater than 50 micrometers, preferably greater than 100 micrometers;
the material constituting said ceramic coating is preferably essentially alumina;
said coating is obtained by thermal spraying,
said coating consists of two layers, preferably of similar chemical composition, that is the difference in chemical composition is less than 5% for its constituent elements;

According to other optional and advantageous additional features said porous ceramic body of said kiln furniture which can be combined if appropriate:
said porous ceramic body in monolithic form is particularly well suited to use in an automated loading and unloading process respectively before and after heat treatment of the alkaline powder;
said porous ceramic body is preferably coated on at least 50% or 60%, in particular 80% or 90%, or even on the entirety of its inner surface of the coating as defined above;
said ceramic body normally comprises a bottom and walls;
said ceramic body comprises little or no free silica, that is silica (SiO₂) which is not combined with another oxide, for example in the form of mullite or cordierite;
the mass content of alkali metal oxides in said porous ceramic body is less than 1%. In particular, that of Na₂O is less than 0.5%;
the mass content of alkaline-earth oxides in said porous ceramic body is less than 1%. In particular, that of K₂O or CaO is less than 0.5%;
the chemical composition of said porous ceramic body made of each metal oxide capable of reacting with the alkali powders is such the mass content of each of the following oxides Cr₂O₃, Fe₂O₃, ZnO or CuO is less than 1%. In order to increase the performance of the material constituting the ceramic body, the content of each of these oxides in the ceramic body is preferably less than 0.5% by weight;
the median pore diameter of said porous ceramic body measured by mercury porosimetry is between 0.1 and 10 μm;
said porous ceramic body preferably has a volume of at least 1 dm³, in particular 2 or more than 3 dm³.

The invention also relates to a method for manufacturing a kiln furniture according to the invention, wherein the coating is formed by thermal spraying by depositing a plurality of superimposed layers of molten particles which are then solidified by cooling. Among the techniques known to the person skilled in the art, flame spraying and plasma spraying are preferred.

In particular, according to the method for manufacturing the furniture of the invention as described above, the porous ceramic body is coated with said coating by thermal spraying, the ceramic particles used for spraying having a mass content of the sum of the oxides Al₂O₃+MgO+Li₂O+Y₂O₃+ZrO₂+HfO₂ greater than 99.9%.

According to one possible embodiment, the median diameter of the population of said particles is between 10 and 50 micrometers, preferably greater than 10 micrometers and/or less than or equal to 40 micrometers. Preferably, the ratio (D₉₀-D₁₀)/D₁₀ of the diameter of the particles is less than 3, preferably less than 2.

The porous ceramic body, preferably a saggar or crucible, is obtained by conventional techniques known to the person skilled in the art.

According to one possible embodiment, the porous ceramic body is made of the material Alundum® AN199B sold by Saint-Gobain Performance Ceramics & Refractories. According to another embodiment, the material of the porous ceramic body is Si₃N₄-bonded SiC, typically obtained by reactive sintering, for example made of an N-durance® material sold by Saint-Gobain Performance Ceramics & Refractories. The porous ceramic body can be obtained for example by reactive sintering of preforms made from mixtures or suspensions containing silicon and/or silicon nitride powder, in particular techniques described in applications WO 2007/148986, WO 2004/016835 or WO 2012/084832.

The coating according to the invention can be obtained by thermal spraying consisting of at least partial melting of particles which are sprayed onto the porous ceramic body. The mixture of particles is preferably very low in impurities, such that the content levels of SiO₂, Na₂O, K₂O, Cr₂O₃, ZnO, CuO and Fe₂O₃ in particular are very small. In particular, a mass content of the sum of the oxides Al₂O₃+MgO+Li₂O+Y₂O₃+ZrO₂+HfO₂ greater than 99.9% is particularly advantageous for better control of the solidification-recrystallization phase after spraying the molten particles onto the porous ceramic body.

The mass content of the population of spray particles whose mass content of the sum of SiO₂+Na₂O+Fe₂O₃ oxides is preferably less than 0.05%. This advantageously makes it possible to control the grain boundaries and ensure perfect cohesion of the coating.

Preferably, the median diameter of the population of particles to be sprayed is between 20 and 40 micrometers. Such a range is particularly suitable for obtaining the size of the grains of the coating according to the invention having the best performance.

According to one possible mode, the method for depositing the coating consists of thermal spraying by flame consisting of spraying particles from a cord passing in front of the flame from a spray gun within which a gaseous mixture of acetylene and oxygen is produced so as to at least partially melt the ceramic particles of the cord. Typically, a cord of the Alumina Supra Flexicord® type supplied by Saint-Gobain Coating Solutions is particularly suitable, given the diameter of the alumina particles of the cord (median diameter of the population of particles is 10 to 15 micrometers) and the very high purity of the alumina grains (>99.9% Al₂O₃). A flame gun of the Master Jet® type is particularly suitable for this type of spraying.

According to another possible embodiment, the deposition of the coating consists of plasma spraying, for example using a Proplasma torch similar to that shown in FIG. 1 of EP2407012B1 fed with a ceramic powder, for example an alumina powder with a purity greater than 99% and a median diameter of between 10 and 100 micrometers.

Regardless of the spraying method used, the substrate formed by the porous ceramic body is preheated to a temperature of between 20° and 400° C., preferably in air and at atmospheric pressure. The spraying is done with the axis of the thermal spraying tool normal to the surface, performing translations and crenellations with overlap.

The coated porous ceramic body is then placed in an oven between 20° and 400° C., preferably in air and subjected to a controlled temperature drop of less than 200° C./h.

According to one possible embodiment, several deposits can be carried out but preferably the porous ceramic body after deposition of a first layer is temperature-stabilized in a furnace between 20° and 400° C. before the deposition of a second layer.

The invention also relates to the use of a kiln furniture according to the invention as described above for the heat treatment of the powders of an alkali metal, in particular comprising lithium, intended for the manufacture of batteries.

### BRIEF DESCRIPTION OF THE FIGURES

The invention will be better understood in light of the following non-limiting examples, shown by FIGS. 1 to 3.

FIGS. 1 to 3 show a cross-section of a porous ceramic body 1 with its coating 2, respectively for examples 1 to 3.

### DEFINITION

For the sake of clarity, the chemical formulae of the corresponding simple oxides are used, even if they are not actually present, to designate the content levels of these oxides in a composition. For example, “SiO₂” or “Al₂O₃” refers to the contents of these oxides in said composition and the expressions “silica” and “alumina” are used to denote phases of these oxides actually present and consisting of SiO₂ and Al₂O₃, respectively.

The oxides are typically determined by X-ray or ICP fluorescence analysis according to the measured contents.
Unless otherwise mentioned, all the contents of oxides are mass percentages on the basis of the oxides. A mass content of an oxide of a metal element relates to the total content of this element expressed in the form of the most stable oxide, according to the usual convention of the industry.
HfO₂ is not chemically dissociable from ZrO₂ when HfO₂ is not intentionally added. That is because this oxide is always naturally present in zirconia sources at mass contents generally less than 5%, generally less than 2%. Symmetrically, during a deliberate addition of HfO₂, there may be inevitable impurities of zirconium oxide. For the sake of clarity, the total content of zirconium oxide and of traces of hafnium oxide can be denoted interchangeably as “ZrO₂” or as “ZrO₂+HfO₂” and vice versa for “HfO₂”.
The sum of contents of oxides does not imply the presence of all these oxides.
A “sialon”, SiAlON, is a compound of oxynitride of at least the elements Si, Al and N, in particular a compound complying with one of the following formulas:
SiₓAl_{y}OᵤNᵥ, wherein:
x is greater than or equal to 0
y is greater than or equal to 0
u is greater than 0
v is greater than 0

$$x + y > 0$$

MeₓSi₁₂₋₍ₘ₊ₙ₎ Al₍ₘ₊ₙ₎ OₙN₁₆₋ₙ, where 0≤x≤2, Me is a cation selected from lanthanide, Fe, Y, Ca, Li cations and mixtures thereof, 0≤m≤12, 0≤n≤12 and 0<n+m≤12, generally called “α”-SiAlON” or “SiAlON-α”.
“Ceramic Matrix Composite” or “CMC” is conventionally understood to mean a product composed of ceramic fibers rigidly linked together by a ceramic matrix.
“Ceramic” is understood to mean a product which is neither metallic nor organic. In the context of the present invention, an oxide glass and carbon are considered to be ceramic products.
“Coating” is understood to mean one or more layers of material(s). At least one of said layers, in particular the layer comprising a compound selected from alumina, lithium aluminate, magnesia-alumina spinel, zirconia, preferably stabilized for example by yttrium, hafnia, yttria. This layer may be the result of the reaction of the ceramic body and of the deposition by thermal spraying of the particles on the surface of said ceramic body.
Unless otherwise indicated, the term “pores” refers to all pores.
The porosity and the size of the pores of the ceramic body can be determined using a mercury porosimeter in application of the Washburn law mentioned in standard ISO 15901-1.2005 part 1. From a cube-shaped sample of about 1 cm³, a mercury porosimeter makes it possible to establish a volume distribution of the pores by volume, that is to say to determine, for each pore size, a volume occupied by the pores having this size. It is thus possible to determine an equivalent diameter (also called median pore diameter D₅₀) corresponding to the 50th percentile of the median size of the population of pores of the ceramic body. This size splits said population into two groups by volume: one group representing 50% of the pore volume, whose pores have a size smaller than the median size, and another group representing 50% of the pore volume, whose pores have a size greater than or equal to said median size.
The size or diameter of the pores or grains of the coating or the size of the grains of the porous ceramic body are determined by analyzing images of cross-sections observed under a scanning electron microscope with a magnification of at least 1000, preferably equal to 2000. The area and diameter of each of the grains or pores are obtained from images by conventional image analysis techniques, optionally after a binarization or segmentation of the image that aims to increase the contrast thereof. A distribution of grain diameters by percentage (by number) or of pores in percentage (by volume) is thus deduced, from which the median diameter of grains or pores corresponding to the percentile D₅₀ is extracted. It is also possible to determine from this distribution the percentiles D₁₀ and D₉₀ or D₁₀₀ of the grain (or pore) population diameter which are the grain (or pore) diameters corresponding respectively to the percentages of 10% and 90% or 100% on the cumulative distribution curve of the diameter of grains by number (or of pores by volume) classified in increasing order obtained by image analysis of said coating cross-section or porous ceramic body. By integrating the volume pore distribution curve, it is possible to deduce the volume of pores or total porosity of the coating or of the porous ceramic body. From such a cumulative pore volume distribution, it is also possible to calculate a volume fraction of pores greater than or equal to a predetermined pore size, in particular the volume fraction of pores with a diameter greater than or equal to 2 micrometers in said coating.

“Comprise” should be interpreted non-limitingly, in the sense that elements other than those indicated may be present.

### EXAMPLES

The following examples are provided for purposes of illustration and do not limit the scope of the invention.

Saggars with an overall square cross-section of dimensions 200*200*100 mm³ and wall thickness 10 mm made of an Alundum® AN199B material (chemical composition Al₂O₃: 99.5%; SiO₂: 0.07%; Fe₂O₃: 0.03%; K₂O+Na₂O: 0.1%; other oxides: 0.3%) sold by Saint-Gobain Performance Ceramics & Refractories were supplied. The open porosity of the material, measured according to the mercury porosimetry techniques described above, is about 16% (by volume) and its median pore diameter is on the order of 5 micrometers.

According to a first example (comparative example 1), a first series of ten saggars was preheated to a temperature of 300° C. in a furnace before being coated on its interior surface (side and bottom) with an alumina coating by thermal spraying using a flame gun of the Master Jet® type fed by a cord of Flexicord Pure Alumina® with reference code 982101147000 provided by Saint-Gobain Coating Solutions. The saggars are placed in an oven at 300° C., subjected to a controlled 100° C./h decrease in temperature.

According to a second example (example 2 according to the invention), unlike the previous example, on a second series of ten saggars, the layer is deposited using a flame gun of the Master Jet® type fed by a Flexicord Alumina Supra® cord with reference 98210 1347000 provided by Saint-Gobain Coating Solutions. The saggars are placed in an oven at 300° C., subjected to a controlled 100° C./h decrease in temperature.

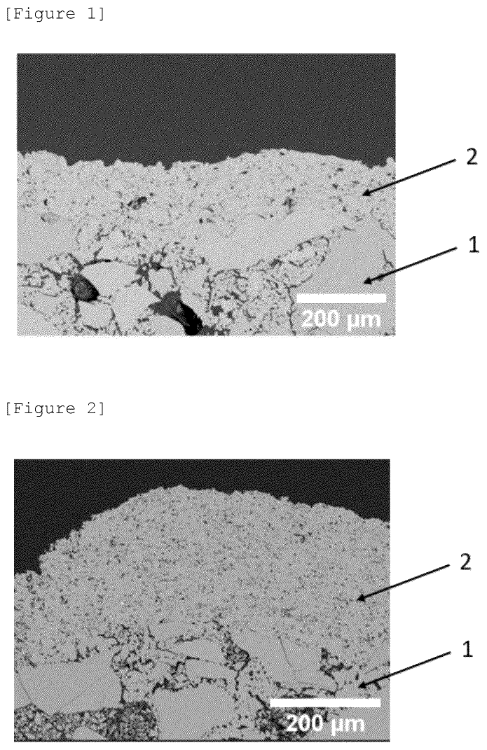

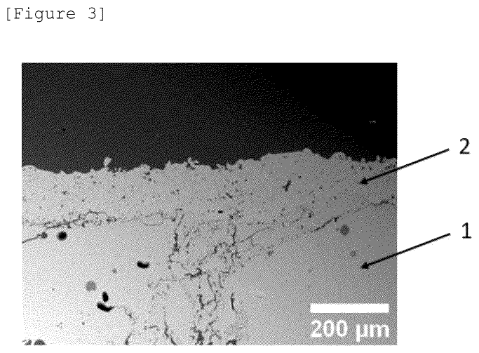

According to a third example (example 3 according to the invention), a series of ten saggars is coated on its inner surface (side and bottom) with an alumina coating by thermal spraying using a Proplasma® torch similar to that shown in FIG. 1 of EP2407012B1 of WO2014/083544 fed with an alumina powder. The substrate formed by the saggar has been preheated to a temperature of 300° C. The plasma spraying is done with the axis of the thermal spraying tool normal to the surface, performing translations and crenellations with overlap. The cooling of the coated gases after plasma spraying of the coating is free.

According to a fourth example (example 4 according to the invention) on a series of ten saggars, an intermediate layer is deposited in a manner similar to example 1 and then a second layer is deposited by plasma spraying in a similar manner to example 3. The cooling of the coated gases after plasma spraying of the coating is free.

Characterization methods and performance tests:

The average thickness of the whole coating was determined by observation with a scanning electron microscope.

The size of the grains and of the pores constituting the coating comprises the succession of the following steps, which is conventional in the field:

A series of five SEM images is taken from the furniture in a cross-section (that is to say throughout the thickness of a wall). For more clarity, the images are made on a polished section of the material. The image acquisition is carried out over a cumulative length of the coating at least equal to 1.5 cm, in order to obtain values representative of the whole sample.
The images are subjected to binarization techniques, well known in image processing techniques, to increase the contrast of the contour of the grains or of the pores.
For each grain or each pore, a measurement of its area is carried out. A pore or grain diameter is determined, corresponding to the diameter of a perfect disc of the same area as that measured for said grain or for said pore (this operation possibly being carried out using dedicated software, in particular Visilog® sold by Noesis).

A distribution of particle or grain size or of pore diameter is thus obtained according to a conventional distribution curve and a median size of the grains or pores constituting the coating is thus determined, this median size respectively corresponding to the diameter dividing said distribution into a first population comprising only grains with a diameter greater than or equal to this median size and a second population comprising only grains or pores with a diameter lower than this median size or this median diameter. Likewise, it is possible to calculate the volume fraction of pores with a size of less than or equal to 2 micrometers.

In example 4, the measurements (median grain size, porosity, pore diameter) were carried out by analyzing images of both the two layers constituting the coating.

The corrosion resistance of the coating by lithium was evaluated for each example by the following method: A lithium hydroxide powder of purity >99.9% by mass of LiOH was placed in a saggar provided with the coating. The assembly is then placed in an electric furnace under vacuum at a temperature of 900° C. maintained for 8 hours (rise to 900° C. at a speed equal to 500° C./h, natural descent to room temperature by thermal inertia of the furnace. After five cycles, the presence of lithium penetration is observed by image analysis according to the same method as for the average coating thickness:
the resistance is excellent if there is no trace of lithium penetration beyond micrometers deep in the thickness of the coating;
the resistance is considered to be good for a penetration depth between 20 and less than 30 micrometers;
the resistance is considered to be average for a penetration depth greater than 30 and less than 50 micrometers;
the resistance is considered to be mediocre for a penetration depth greater than 50 micrometers;

The thermal shock resistance of the saggar was determined according to the following method: a sample of five saggars previously dried at 110° C. is placed in a furnace then heated up to 900° C., ramping by 250° C./h. The furnace is then maintained at this temperature for one hour. Each saggar is then quickly removed from the furnace to undergo tempering in ambient air (20° C.) for 20 minutes. The operation thus continues until ten cycles are carried out. Each saggar is then analyzed for external and internal observation of the microstructure, in particular of the coating. Observation with the naked eye makes it easy to identify the appearance of external cracks. In particular, very good thermal shock resistance corresponds to an absence of cracks in the coating or at the interface between the coating and the ceramic body. Good thermal shock resistance corresponds to a localized presence of one or more microcracks, which however do not threaten the integrity of the coating.

The deposition conditions are specified in table 1 which follows.

TABLE 1

| | flame gun | flame gun | plasma torch |
|---|---|---|---|
| Examples | deposition | deposition | deposition |
| Supply cord | Pure Alumina | Alumina Supra | |
| Mass mineral | Al₂O₃: 99.7% | Al₂O₃: 99.9% | — |
| composition (%) | other: 0.3% | Fe₂O₃: 0.02%. | |
| of the cord | | SiO₂: 0.02% | |
| | | Na₂O: 0.01% | |
| | | other: 0.05% | |
| FEPA standard size | F320 | F500 | |
| | (D50 = 30 μm) | (D50 = 13 μm) | |
| Cord feed speed | 40 | 40 | — |
| (cm/min) | | | |
| Cord diameter | 4.75 | 4.75 | — |
| (mm) | | | |
| Flow rate of | HB75 at 1.2 bar | HB75 at 1.2 bar | — |
| acetylene (bead | | | |
| height/bar) | | | |
| Flow rate of oxygen | HB65 at 4 bar | HB65 at 4 bar | — |
| (bead height/bar) | | | |
| Air pressure (bars) | 4.5 | 4.0 | — |
| Masterjet ® gun | 3769/2941 | 3769/2952 | — |
| gas/air nozzles | | | |
| Spraying distance | 120 | 80 | — |
| (mm) | | | |
| Linear speed of | 300 | 300 | — |
| gun movement | | | |
| (mm/s) | | | |
| increment of | 3 | 3 | — |
| advance (mm) | | | |
| # of passes | 5 | 25 | — |
| Cathode features | — | — | ProPlasma, |
| | | | lanthanum-doped |
| | | | tungsten |
| Anode features | — | — | ProPlasma “Std” |
| | | | Copper material |
| | | | with tungsten insert |
| | | | Diameter: 6.5 mm |
| Median alumina | — | — | 40 μm |
| powder diameter | | | |
| (μm) | | | |
| Mass chemical | — | — | Al₂O₃: 99.9% |
| composition (%) | | | Fe₂O₃: 0.02%. |
| of the injected | | | SiO₂: 0.02% Na₂O: |
| powder | | | 0.01% other: 0.05% |
| Injection rate of the | — | — | 30 |
| powder (g/min) | | | |
| Injection angle % | — | — | 90 |
| the X-axis of the | | | |
| torch | | | |
| Injector radial | — | — | 7 |
| distance - gun axis | | | |
| (mm) | | | |
| Injector diameter | — | — | 1.8 |
| (mm) | | | |
| Flow rate of the | — | — | Argon/4.5 |
| carrier gas (L/min) | | | |
| Voltage (V) | — | — | 69 |
| Plasma arc | — | — | 600 |
| intensity (A) | | | |
| Flow rate of the | — | — | 40 (Argon) |
| primary gas (L/min) | | | |
| Flow rate of the | — | — | 13 (Hydrogen) |
| plasmagen gas | | | |
| (L/min) | | | |

The final composition and morphology as well as the coating properties are reported in table 2 below.

TABLE 2

| | | | |
|---|---|---|---|
| Example 1 | Example 2 | Example 3 | Example 4 |
| comparative | invention | invention | invention |

Characteristics of the method for obtaining the coating

| | | | | |
|---|---|---|---|---|
| 1st deposition | flame | flame | plasma | flame |
| | deposition | deposition | deposition | deposition |
| | Pure | Alumina | | Pure |
| | Alumina | Supra | | Alumina |
| 2nd deposition | No | No | No | plasma |
| | | | | deposition |

Chemical composition of the coating

| | | | | |
|---|---|---|---|---|
| Al₂O₃ (% wt) | >99 | >99 | >99 | >99 |
| SiO₂ (% wt) | <0.01 | <0.01 | <0.02 | <0.01 |
| NaO₂ (% wt) | <0.01 | <0.01 | <0.01 | <0.01 |
| MgO (% wt) | <0.1 | <0.1 | <0.01 | <0.1 |
| Li₂O (% wt) | <0.1 | <0.1 | <0.01 | <0.1 |
| Fe₂O₃ (% wt) | <0.01 | <0.01 | <0.02 | <0.01 |
| ZrO₂ (% wt) | <0.01 | <0.01 | <0.01 | <0.01 |
| HfO₂ (% wt) | <0.1 | <0.1 | <0.01 | <0.1 |
| Y₂O₃ (% wt) | <0.1 | <0.1 | <0.1 | <0.1 |
| Cr₂O₃ + ZnO + | <0.5 | <0.5 | <0.5 | <0.5 |
| Fe₂O₃ + CuO(% wt) | | | | |
| Na₂O + K₂O | <0.5 | <0.5 | <0.5 | <0.5 |

Coating features by image analysis

| | | | | |
|---|---|---|---|---|
| Mean thickness | 150 | 230 | 130 | 280 |
| (μm) | | | | |
| Median grain size | 23 | 10 | 25 | 24 |
| Total porosity (%) | 8.3 | 14.3 | 8.1 | 8.2 |
| Volume fraction | 2.7 | 1.4 | 1.4 | 2.0 |
| of pores ≥ 2 μm | | | | |
| in % | | | | |
| D₅₀: median | 1.0 | 0.8 | 0.7 | Not |
| diameter (μm) | | | | measured |
| D₉₀ (μm) of pores | 4.3 | 2.0 | 2.3 | Not |
| | | | | measured |
| D₁₀₀: maximum | 8.0 | 5.1 | 3.0 | 5.5 |
| pore diameter (μm) | | | | |

Saggar performance tests with its coating

| | | | | |
|---|---|---|---|---|
| Appearance after | No cracks | No cracks | No cracks | No cracks |
| deposition | | | | |
| Thermal shock | very good | good | good | very good |
| resistance | | | | |
| LiOH corrosion | mediocre | good | excellent | excellent |
| resistance | | | | |

The examples according to the invention, the coating of which has a volume fraction of pores greater than or equal to 2 micrometers that is less than 2.5%, as measured by image analysis, show a satisfactory appearance after deposition, good or even very good resistance to thermal shock and good or excellent corrosion resistance, unlike comparative example 1. The examples according to the invention have little adhesion after firing, although the saggars are easily cleaned by blowing or scraping without significant deterioration of the coating after 5 lithium corrosion tests. Example 4 shows that in case of superimposition of deposits, the performance of the coated final furniture is also dependent on the distinctive criterion cited above.

Of course, the invention is not limited to the embodiments described and shown.

1. A kiln furniture for a powder comprising an alkali metal, comprising a porous ceramic body forming a cavity or a container for said powder, wherein said ceramic body is coated on at least part of its inner surface with a ceramic coating, wherein:
a) said porous ceramic body has an open porosity of between 10 and 40%, and an equivalent pore diameter of between 0.5 and 25 micrometers, as measured by mercury and volume porosimetry;
b) said coating has the following characteristics:
the the coating comprises, a layer comprising a compound selected from alumina, a lithium aluminate optionally comprising silicon, a magnesia-alumina spinel, zirconia, hafnia, yttria;
the coating has an average thickness that is between 50 and 500 micrometers;
the coating has a total porosity that is less than 15%, by volume;
the coating has a volume fraction of pores with a diameter greater than or equal to 2 micrometers that is less than 2.5%.

2. The kiln furniture according to the preceding claim 1, wherein the median pore diameter d₅₀ of said ceramic coating is between 0.1 micrometers and 5 micrometers.

3. The kiln furniture according to claim 1, wherein the pore diameter d₉₀ of said ceramic coating is less than 2.5 micrometers.

4. The kiln furniture according to claim 1, wherein median grain size of grains of said ceramic coating is between 5 and 100 micrometers.

5. The kiln furniture according to claim 1, wherein a mass content of alkali metal oxides except Li₂O in said ceramic coating being less than 0.5%.

6. The kiln furniture according to claim 1, wherein a mass content of SiO₂ in said ceramic coating is less than 0.5%.

7. The kiln furniture according to claim 1, wherein a mass content of the sum of the oxides Cr₂O₃+ZnO+Fe₂O₃+CuO in said coating is less than 0.5%.

8. The kiln furniture according to claim 1, wherein a mass content of oxides other than Al₂O₃, MgO, Li₂O, Y₂O₃, ZrO₂, HfO₂ in said ceramic coating is less than 1%.

9. The kiln furniture according to claim 1, wherein a mass content of Al₂O₃ in said ceramic coating is greater than 98%.

10. The kiln furniture according to claim 1, wherein said porous ceramic body comprises alumina, zirconia, magnesia, mullite, cordierite, carbide and/or silicon oxynitride or oxynitride, boron nitride, boron carbide or molybdenum disilicide.

11. The kiln furniture according to claim 1, wherein said porous ceramic body comprises a ceramic matrix composite.

12. The kiln furniture according to claim 1, wherein a mass content of a sum of the oxides ZrO₂+Al₂O₃+SiO₂+MgO in said porous ceramic body is greater than 95%.

13. The kiln furniture according to claim 1, wherein a wall thickness of said porous ceramic body is between 3 and 30 mm.

14. A method for manufacturing a kiln furniture according to claim 1, comprising coating the porous ceramic body with said coating by thermal spraying, wherein the ceramic particles used for spraying having a mass content of the sum of the oxides Al₂O₃+MgO+Li₂O+Y₂O₃+ZrO₂+HfO₂ greater than 99.9%.

15. The method for manufacturing a kiln furniture according to claim 14, wherein a median diameter of the population of said ceramic particles is between 10 and 50 micrometers.

16. A method comprising providing the kiln furniture according to claim 1 for the heat treatment of the powders of an alkali metal intended for the manufacture of batteries.

17. The kiln furniture according to claim 1, wherein the alkali metal is Li.

18. The kiln furniture according to claim 1, wherein the coating consists of said layer.

19. The kiln furniture according to claim 1, wherein the lithium aluminate optionally comprising silicon is LiAlO₂, LiAlSi₂O₆, Li₃AlSiO₅, LiAlSi₄O₁₀, LiAlSiO₄.

20. The kiln furniture according to claim 1, wherein the zirconia is stabilized.
